(19) United States
(12) Patent Application Publication
(10) Pub. No.: US 2025/0025942 A1
(43) Pub. Date: Jan. 23, 2025

(54) ADDITIVE MANUFACTURING METHOD AND ADDITIVE MANUFACTURING DEVICE

(71) Applicant: MITSUBISHI HEAVY INDUSTRIES, LTD., Tokyo (JP)

(72) Inventors: Ryuichi Narita, Tokyo (JP); Masashi Kitamura, Tokyo (JP); Shuji Tanigawa, Tokyo (JP)

(73) Assignee: MITSUBISHI HEAVY INDUSTRIES, LTD., Tokyo (JP)

(21) Appl. No.: 18/574,985

(22) PCT Filed: Jun. 30, 2022
(86) PCT No.: PCT/JP2022/026237

§ 371 Date: Dec. 28, 2023

(30) Foreign Application Priority Data
Jul. 30, 2021 (JP) 2021-125872

(51) Int. Cl. B22F 12/49; B28B 1/00; B33Y 30/00

(52) U.S. Cl. CPC B22F 12/49; B28B 1/001; B33Y 30/00

(57) ABSTRACT

An additive manufacturing method according to one or more embodiments includes a step for feeding a raw-material powder and forming a layer of the raw-material powder and a step for irradiating the layer with a light beam to cause the raw-material powder in the layer to melt and solidify, and thereby molding a part of a molded object. In the molding step, the beam diameter of the light beam on the molding surface is changed partway through molding, within the same layer.

### DESCRIPTION

### Technical Field

The present disclosure relates to an additive manufacturing method and an additive manufacturing device. The present application claims priority based on Japanese Patent Application No. 2021-125872 filed in Japan on Jul. 30, 2021, the contents of which are incorporated herein by reference.

### Background Art

Among additive manufacturing methods in which additive manufacturing is performed to form a three-dimensional object, for example, in the additive manufacturing method using a powder bed method, with emission of an energy beam such as a light beam or an electron beam to metal powders, which are raw-material powders laid in a layered state, lamination is performed by repeatedly performing melting solidification to form the three-dimensional object (manufactured object) (refer to PTL 1).

### CITATION LIST

### Patent Literature

[PTL 1] Japanese Unexamined Patent Application Publication No. 2019-094515

### SUMMARY OF INVENTION

### Technical Problem

For example, in the additive manufacturing method using the powder bed method, since the manufactured object is formed by the method as described above, it takes a longer working time to complete the manufactured object as a size of the manufactured object is larger.

At least one embodiment of the present disclosure is made in view of the above circumstances, and an object thereof is to provide an additive manufacturing method and an additive manufacturing device capable of shortening a production time of a manufactured object.

### Solution to Problem

(1) According to at least one embodiment of the present disclosure, an additive manufacturing method includes

a step of supplying a raw-material powder to form a layer of the raw-material powders, and

a step of manufacturing a part of a manufactured object by emitting a light beam to the layer to melt and solidify the raw-material powders of the layer,

in which in the step of manufacturing, a beam diameter of the light beam on a build surface is changed during the manufacturing in the same layer.

(2) According to at least one embodiment of the present disclosure, an additive manufacturing device includes

a powder bed forming part having a base plate where a layer made of supplied raw-material powders is formed, and

a light beam irradiation part that is able to emit a light beam to the layer,

in which the light beam irradiation part is configured to be able to change a beam diameter of the light beam on a build surface during manufacturing in the same layer.

### Advantageous Effects of Invention

According to at least one embodiment of the present disclosure, it is possible to shorten the production time of the manufactured object.

### BRIEF DESCRIPTION OF DRAWINGS

FIG. 1 is a schematic diagram showing an overall configuration of a three-dimensional additive manufacturing device, which is an additive manufacturing device to which an additive manufacturing method according to at least one embodiment can be applied.

FIG. 2 is a flowchart showing a processing procedure in the additive manufacturing method according to some embodiments.

FIG. 3 is a flowchart showing a processing procedure in a subroutine of a manufacturing step in the flowchart shown in FIG. 2.

FIG. 4A is a diagram showing an overall configuration of a light beam irradiation part according to an embodiment among light beam irradiation parts according to some embodiments.

FIG. 4B is a diagram showing an overall configuration of a light beam irradiation part according to another embodiment among the light beam irradiation parts according to some embodiments.

FIG. 4C is a diagram showing an overall configuration of a light beam irradiation part according to still another embodiment among the light beam irradiation parts according to some embodiments.

FIG. 5A is a perspective view of a manufactured object having a rectangular solid shape.

FIG. 5B is a schematic diagram, in a case where a cross section of the manufactured object shown in FIG. 5A in a horizontal direction is manufactured, of a powder bed immediately after formation of a layer of raw-material powders and before emission of a light beam, as viewed from above.

FIG. 5C is a diagram showing a locus of the light beam emitted to the layer of the raw-material powders in FIG. 5B.

FIG. 5D is a diagram showing a locus of the light beam emitted to the layer of the raw-material powders in FIG. 5B.

FIG. 6A is a diagram schematically showing a case where the manufactured object includes a thin wall portion having a relatively thin thickness.

FIG. 6B is a diagram representing a cross section of the thin wall portion shown in FIG. 6A, as viewed from a z-direction.

FIG. 7 is a diagram representing a case where the manufactured object as shown in FIG. 6A is manufactured in a three-dimensional additive manufacturing device in the related art.

### DESCRIPTION OF EMBODIMENTS

Hereinafter, some embodiments of the present disclosure will be described with reference to the accompanying drawings. However, dimensions, materials, shapes, relative dispositions, and the like of components, which are described as the embodiments or shown in the drawings, are not intended to limit the scope of the present disclosure and are merely explanatory examples.

For example, expressions such as “in a certain direction”, “along a certain direction”, “parallel”, “orthogonal”, “center”, and “concentric” or “coaxial”, which represent relative or absolute dispositions, not only strictly represent such a disposition but also represent a state of relative displacement with a tolerance or at an angle or distance to the extent that the same function can be obtained.

For example, expressions such as “identical”, “equal”, and “homogeneous”, which represent that things are in an equal state, not only strictly represent the equal state but also represent a state where a tolerance or a difference to the extent that the same function can be obtained is present.

For example, an expression representing a shape such as a quadrangular shape or a cylindrical shape not only represents a shape such as a quadrangular shape or a cylindrical shape in a geometrically strict sense but also represents a shape including an undulating portion, a chamfering portion, or the like within a range where the same effect can be obtained.

On the other hand, the expressions “being provided with”, “composing”, “including”, or “having” one component are not exclusive expressions excluding the presence of other components.

### (Regarding Three-Dimensional Additive Manufacturing Device 1)

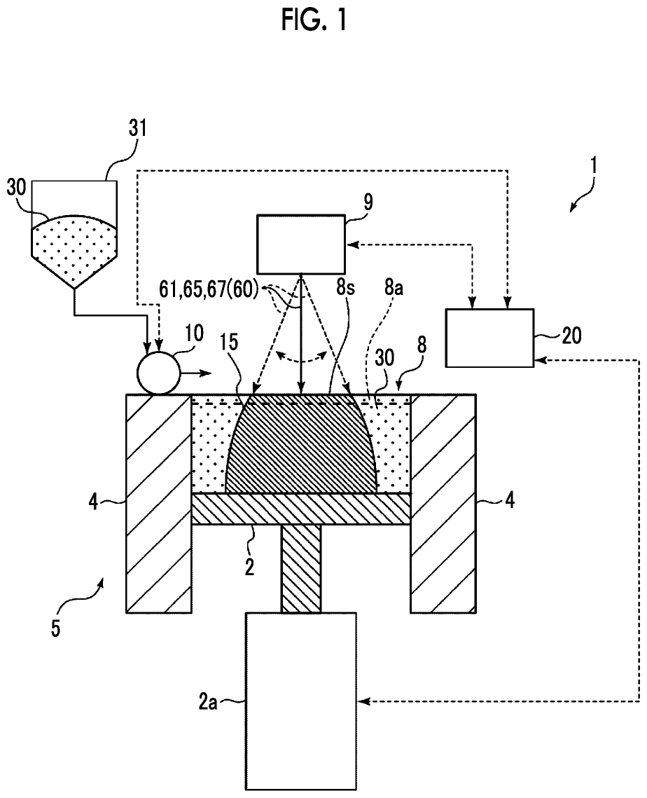

FIG. 1 is a schematic diagram showing an overall configuration of a three-dimensional additive manufacturing device 1, which is an additive manufacturing device to which the additive manufacturing method according to at least one embodiment of the present disclosure can be applied.

The three-dimensional additive manufacturing device 1 is a device that performs additive manufacturing by irradiating, with a light beam 60 as an energy beam, metal powders, which are raw-material powders laid in a layered state to produce a manufactured object 15 having a three-dimensional shape, and can perform the additive manufacturing using a powder bed method.

The three-dimensional additive manufacturing device 1 shown in FIG. 1 can form, for example, a rotor blade or stator vane of a turbine such as a gas turbine or a steam turbine, or a component such as an inner cylinder, a transition piece, or a nozzle of a combustor.

The three-dimensional additive manufacturing device 1 shown in FIG. 1 includes a storage part 31 for a raw-material powder 30. The three-dimensional additive manufacturing device 1 shown in FIG. 1 includes a powder bed forming part 5 having a base plate 2 on which a powder bed 8 obtained by sequentially laminating layers 8a, which are made of the raw-material powders 30 supplied from the storage part 31, is formed. The three-dimensional additive manufacturing device 1 shown in FIG. 1 includes a light beam irradiation part 9 capable of irradiating the powder bed 8 with the light beam 60. The three-dimensional additive manufacturing device 1 shown in FIG. 1 includes a powder laying part 10, a drive cylinder 2a of the base plate 2, and a control device 20 capable of controlling the light beam irradiation part 9, which are described below.

The base plate 2 serves as a base on which the manufactured object 15 is manufactured. The base plate 2 is disposed to be able to move up and down by the drive cylinder 2a on an inner side of a substantially cylindrical cylinder 4 having a central axis along a vertical direction. In the powder bed 8 formed on the base plate 2, the raw-material powder 30 is laid on an upper layer side of the powder bed 8 each time the base plate 2 is lowered in each cycle during a manufacturing work to form a new layer 8a.

The three-dimensional additive manufacturing device 1 shown in FIG. 1 includes the powder laying part 10 for laying the raw-material powder 30 on the base plate 2 to form the layer 8a made of the raw-material powders 30. The powder laying part 10 supplies the raw-material powders 30 to an upper surface side of the base plate 2 from the storage part 31 and flattens a surface thereof to form the layer 8a having a substantially uniform thickness over the entire upper surface of the base plate 2. Solidification is selectively performed by the emission of the light beam 60 from the light beam irradiation part 9 and in a next cycle, the raw-material powder 30 is laid on the upper layer side again by the powder laying part 10 to form a new layer 8a on the powder bed 8, which is formed in each cycle and obtained by the sequential lamination of the layers 8a. With the above, the raw-material powders 30 are laminated in a layered state.

The raw-material powder 30 supplied from the powder laying part 10 is a powdery substance that is a raw material for the manufactured object 15, and can widely employ, for example, a metallic material such as iron, copper, aluminum, or titanium, or a non-metallic material such as ceramic.

The control device 20 shown in FIG. 1 is a control unit of the three-dimensional additive manufacturing device 1 shown in FIG. 1, and is configured by an electronic calculation device such as a computer.

In the control device 20 shown in FIG. 1, information regarding a scanning position of the light beam 60 for each layer 8a is input as information necessary for manufacturing the manufactured object 15. Information regarding an emission position of the light beam 60 for each layer 8a may be input from, for example, an external device and stored in, for example, a storing part (not shown) of the control device 20.

For example, in the additive manufacturing method using the powder bed method, the formation of the layer 8a and the emission of the light beam 60 to the layer 8a are repeatedly implemented to produce the manufactured object 15. Therefore, it takes a longer working time to complete the manufactured object 15 as a size of the manufactured object 15 is larger.

In the additive manufacturing method according to some embodiments of the present disclosure, a time required for the manufacturing is shortened by producing the manufactured object 15 follows. as Hereinafter, an additive manufacturing method according to some embodiments of the present disclosure will be described.

### (Flowchart)

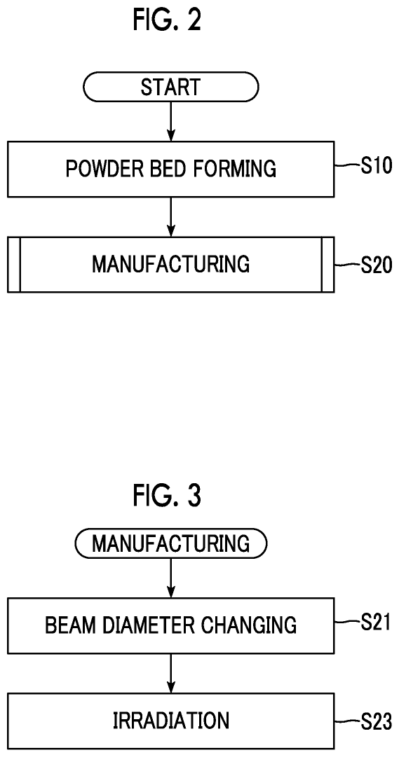

FIG. 2 is a flowchart showing a processing procedure in the additive manufacturing method according to some embodiments.

FIG. 3 is a flowchart showing a processing procedure in a subroutine of a manufacturing step S20 in the flowchart shown in FIG. 2.

The additive manufacturing method according to some embodiments shown in FIGS. 2 and 3 includes a powder bed forming step S10 and the manufacturing step S20.

In the additive manufacturing method according to some embodiments shown in FIGS. 2 and 3, the manufactured object 15 can be formed by repeatedly implementing the powder bed forming step S10 and the manufacturing step S20.

### (Powder Bed Forming Step S10)

The powder bed forming step S10 is a step of supplying the raw-material powder 30 to form the layer 8a of the raw-material powders 30. That is, in the powder bed forming step S10, the raw-material powder 30 is supplied from the storage part 31 to the powder bed 8, and the raw-material powder 30 is laminated with a predetermined thickness.

Specifically, the control device 20 according to some embodiments controls the drive cylinder 2a such that the base plate 2 is lowered with a lowering amount equal to the predetermined thickness.

Next, the control device 20 according to some embodiments controls the powder laying part 10 to supply the raw-material powder 30 to the upper surface side of the base plate 2.

With the execution of the powder bed forming step S10, the layer 8a of the raw-material powders 30 laminated with the predetermined thickness is formed on the upper portion of the powder bed 8.

### (Manufacturing Step S20)

In the manufacturing step S20, with the emission of the light beam 60 to the layer 8a, the raw-material powders 30 of the layer 8a are melted and solidified to manufacture a part of the manufactured object 15, as will be described below.

The manufacturing step S20 includes a beam diameter changing step S21 and a beam irradiation step S23.

In the beam diameter changing step S21, a beam diameter of the light beam 60 on a build surface 8s during the manufacturing is changed in the same layer 8a. Details of the beam diameter changing step S21 will be described below.

In the beam irradiation step S23, the light beam 60 having the beam diameter of the light beam 60 set in the beam diameter changing step S21 is emitted to the layer 8a. Details of the beam irradiation step S23 will be described below.

Prior to the description of the manufacturing step S20, the overall configuration of the light beam irradiation part 9 according to some embodiments will be described.

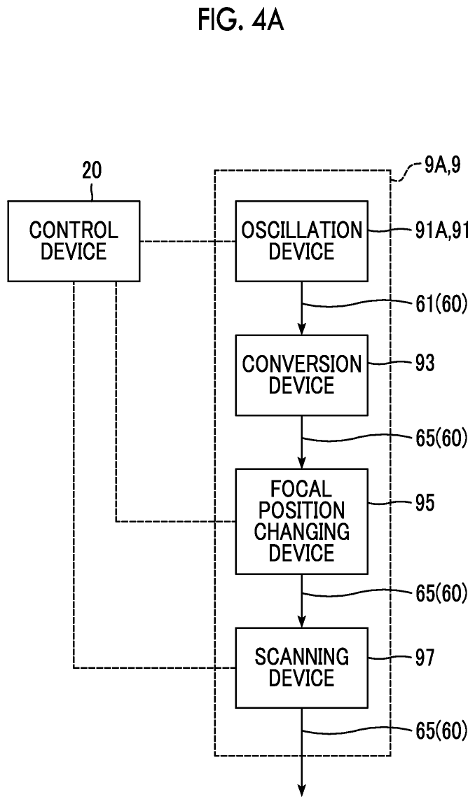

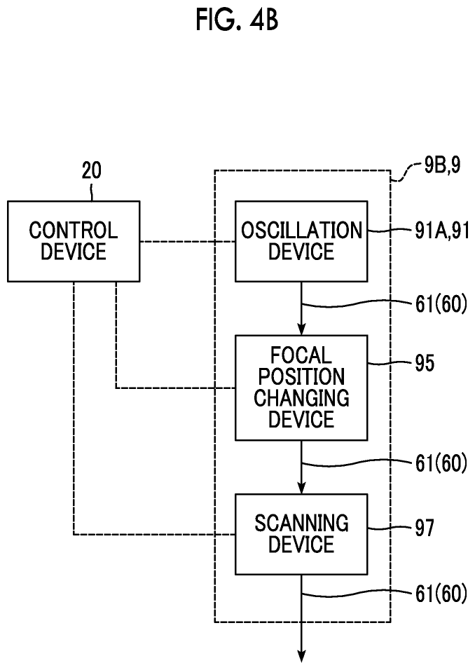

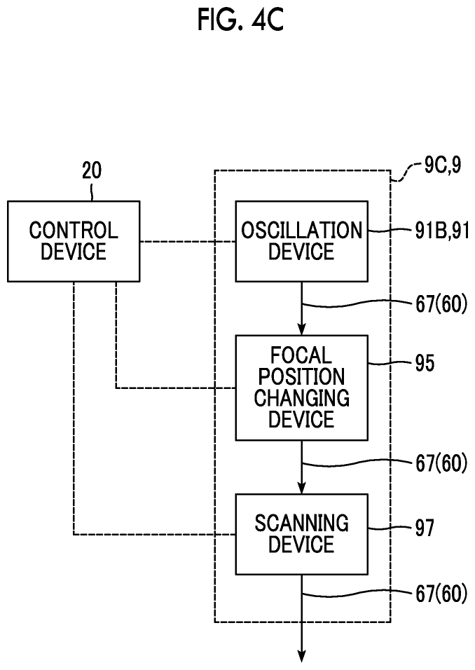

FIG. 4A is a diagram showing an overall configuration of a light beam irradiation part 9A according to an embodiment among the light beam irradiation parts 9 according to some embodiments.

FIG. 4B is a diagram showing an overall configuration of a light beam irradiation part 9B according to another embodiment among the light beam irradiation parts 9 according to some embodiments.

FIG. 4C is a diagram showing an overall configuration of a light beam irradiation part 9C according to still another embodiment among the light beam irradiation parts 9 according to some embodiments.

In the embodiment shown in FIG. 4A, the light beam irradiation part 9A includes an oscillation device 91, a conversion device 93, a focal position changing device 95, and a scanning device 97.

In the embodiment shown in FIG. 4B, the light beam irradiation part 9B includes the oscillation device 91, the focal position changing device 95, and the scanning device 97.

In the embodiment shown in FIG. 4C, the light beam irradiation part 9C includes the oscillation device 91, the focal position changing device 95, and the scanning device 97.

In the following description, as will be described below, in a case where a first light beam 61, a second light beam 65, and a third light beam 67 having different patterns of an intensity distribution are collectively referred to, a reference numeral 60 is assigned.

In the following description, it is assumed that the pattern of the intensity distribution refers to a type of a beam shape such as a top hat shape or a donut shape.

Further, in the following description, it is assumed that a change of the pattern of the intensity distribution or a conversion of the pattern of the intensity distribution means a change or conversion of the type of the beam shape, for example, a change or conversion of a beam having the top hat shape into a beam having the donut shape.

Further, in the following description, it is assumed that the change of the intensity distribution includes, in addition to the change of the pattern of the intensity distribution described above, a change of a beam profile such as, without changing the pattern of the intensity distribution, a change of the beam diameter in a region where the intensity is relatively high or a change of an intensity ratio between a region near the center in a radial direction and a region near an outer side in the radial direction.

In the light beam irradiation part 9 shown in FIGS. 4A to 4C, the oscillation device 91 outputs the light beam 60 based on a control signal from the control device 20. For example, in a case where the control signal from the control device 20 includes information regarding the output of the light beam 60, the oscillation device 91 outputs (emits) the light beam 60 with an output corresponding to the information.

In the embodiment shown in FIGS. 4A and 4B, the oscillation device 91 is a first oscillation device 91A. The first oscillation device 91A is configured to be able to output the first light beam 61 having the intensity distribution in a TEM₀₀ mode, which is referred to as, for example, a Gaussian beam.

In the embodiment shown in FIG. 4C, the oscillation device 91 is a second oscillation device 91B. The second oscillation device 91B is configured to be able to coaxially output, for example, two light beams having different intensity distributions. The second oscillation device 91B is configured to change a ratio of the outputs of the two light beams having different intensity distributions such that the intensity distribution of the third light beam 67 to be output can be changed. That is, with the change of the ratio of the outputs of the two light beams having different intensity distributions, the second oscillation device 91B is configured to change the beam profile, such as a change of the pattern of the intensity distribution of the third light beam 67 to be output or the change of the intensity ratio, without changing the pattern of the intensity distribution, between the region near the center in the radial direction and the region near the outer side in the radial direction.

In a case where the control signal from the control device 20 includes information regarding the intensity distribution of the third light beam 67, the second oscillation device 91B outputs (emits) the third light beam 67 having an intensity distribution corresponding to the information.

In the embodiment shown in FIG. 4A, the conversion device 93 converts the pattern of the intensity distribution of the first light beam 61 output from the oscillation device 91 (first oscillation device 91A). The conversion device 93 is configured to convert the first light beam 61 having the pattern of the intensity distribution in the TEM₀₀ mode, which is output from the first oscillation device 91A, into the second light beam 65 having the pattern of the intensity distribution of, for example, the top hat shape or the donut shape. In the embodiment shown in FIG. 4A, the conversion device 93 may be a device referred to as, for example, a beam shaper or a beam homogenizer.

The pattern of the intensity distribution of the second light beam 65 differs depending on a position of the second light beam 65 in an axial direction from a focal position (beam waist). That is, in the second light beam 65, the pattern of the intensity distribution may be the top hat shape or the donut shape depending on the position of the second light beam 65 in the axial direction from the beam waist. Further, in the second light beam 65, the beam diameter of the second light beam 65 differs depending on the position of the second light beam 65 in the axial direction from the beam waist.

In the embodiments shown in FIGS. 4A to 4C, the focal position changing device 95 changes the focal position of the light beam 60. In the embodiments shown in FIGS. 4A to 4C, the focal position changing device 95 can change a positional relationship between the beam waist of the light beam 60 emitted to the layer 8a and the build surface 8s (that is, surface of layer 8a) based on the control signal from the control device 20.

In the embodiments shown in FIGS. 4A to 4C, the scanning device 97 is configured to be able to emit the light beam 60, which is output from the focal position changing device 95, while scanning toward the powder bed 8. The scanning device 97 is configured to scan with the light beam 60 based on the control signal from the control device 20.

### (Beam Diameter Changing Step S21)

In the beam diameter changing step S21, the beam diameter of the light beam 60 on the build surface 8s is changed during the manufacturing in the same layer 8a. That is, in the beam diameter changing step S21, the pattern of the intensity distribution of the light beam 60 on the build surface 8s is changed during the manufacturing or the position of the beam waist with respect to the build surface 8s is changed, in the same layer 8a, to change the beam diameter of the light beam 60 on the build surface 8s.

Accordingly, since the diameter of the light beam 60 on the build surface 8s can be changed during manufacturing in the same layer 8a, with reduction in the number of bead passes by widening an overlap margin (hatch spacing) between beads, it is possible to shorten the time required for the manufacturing.

Hereinafter, in the beam diameter changing step S21, a reason for changing the diameter of the light beam 60 on the build surface 8s during manufacturing in the same layer 8a will be described.

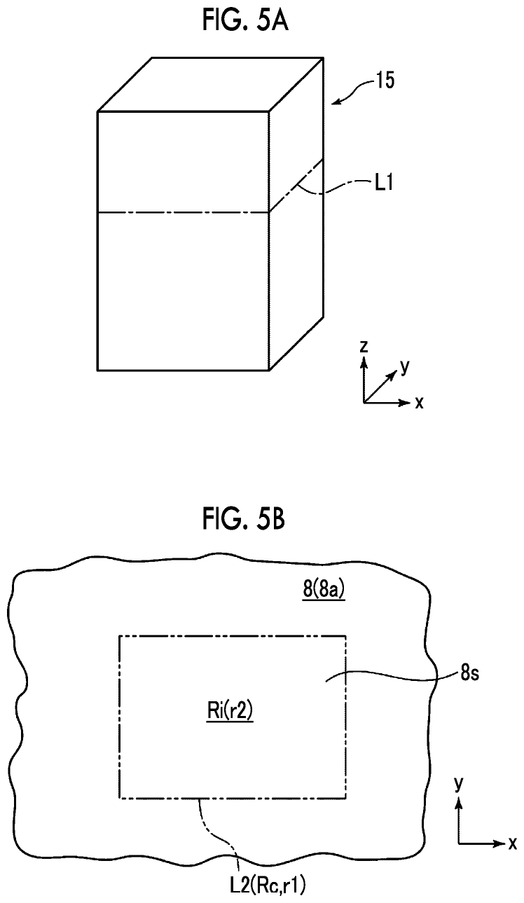

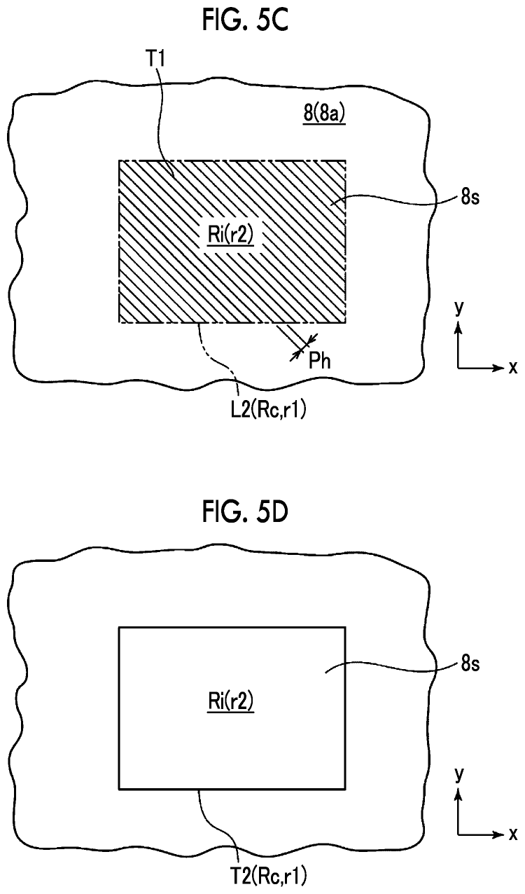

FIG. 5A is a perspective view of the manufactured object 15 having a rectangular solid shape as an example of the manufactured object 15. In FIG. 5A, it is assumed that extending directions of three sides coming from one apex of a rectangular body are an x-direction, a y-direction, and a z-direction, respectively. In a case of the manufacturing in the three-dimensional additive manufacturing device 1, the z-direction matches the vertical direction, and the x-direction and the y-direction match a horizontal direction.

FIG. 5B is a schematic diagram, in a case where a cross section of the manufactured object 15 shown in FIG. 5A in the horizontal direction is manufactured, of the powder bed 8 immediately after the formation of the layer 8a of the raw-material powders 30 and before the emission of the light beam 60, as viewed from above. It is assumed that FIG. 5B shows a case where, for example, a surface of the manufactured object 15 shown in FIG. 5A, to which a one-point chain line L1 is assigned, is manufactured. In FIG. 5B, a square indicated by a two-point chain line L2 represents a position corresponding to a contour of the manufactured object 15 shown in FIG. 5A.

FIG. 5C is a diagram showing a locus of the light beam 60 emitted to the layer 8a of the raw-material powders 30 in FIG. 5B, and shows a locus T1 for manufacturing a region on an inner side of the contour of the manufactured object 15.

FIG. 5D is a diagram showing a locus of the light beam 60 emitted to the layer 8a of the raw-material powders 30 in FIG. 5B, and shows a locus T2 for manufacturing a region corresponding to the contour of the manufactured object 15.

In the manufacturing of the manufactured object 15 as shown in FIG. 5A, the layer 8a of the powder bed 8 is melted and solidified in a planar shape to manufacture a cross-sectional portion of the manufactured object 15 and then the region corresponding to the contour of the manufactured object 15 is melted and solidified to manufacture a contour portion of the manufactured object 15. In this case, in the layer 8a shown in FIG. 5B, the light beam 60 is emitted to a region Ri on an inner side of a region Rc corresponding to the contour of the manufactured object 15 indicated by the two-point chain line L2, at a constant hatch spacing Ph as shown in FIG. 5C, to manufacture a portion corresponding to the cross-sectional portion of the manufactured object 15. Then, in the layer 8a shown in FIG. 5C, the light beam 60 is emitted along the contour of the manufactured object 15 indicated by the two-point chain line L2 to manufacture the contour portion of the manufactured object 15.

For example, in the layer 8a shown in FIG. 5B, with the change of the beam diameter of the light beam 60 in the region Ri on the inner side of the region Rc corresponding to the contour of the manufactured object 15 indicated by the two-point chain line L2, the dimensional accuracy of the manufactured object 15 is hardly affected even in a case where a width of the bead to be formed is changed. Therefore, in the region Ri on the inner side of the region Rc corresponding to the contour of the manufactured object 15, the width of the formed bead can be increased by making the beam diameter of the light beam 60 larger than the beam diameter of the light beam 60 in the additive manufacturing in the related art. Accordingly, with the increase in the hatch spacing Ph of the light beam 60 in the region Ri and the reduction in the number of bead passes required for the formation of the region Ri, it is possible to shorten the time required for manufacturing the region Ri.

On the contrary, for example, in the layer 8a shown in FIG. 5B, with the change of the beam diameter of the light beam 60 in the region Rc corresponding to the contour of the manufactured object 15, there is a relatively large effect on the dimensional accuracy of the manufactured object 15 in a case where the width of the formed bead is changed. Therefore, in the region Rc corresponding to the contour of the manufactured object 15, the light beam with a beam diameter equivalent to the beam diameter of the light beam 60 in the additive manufacturing in the related art may be emitted.

As described above, in some embodiments, in the manufacturing step S20, the light beam 60 having the beam diameter of the light beam 60 on the build surface 8s of a first beam diameter D1 may be emitted to a first region r1 in the same layer 8a, and the light beam 60 having the beam diameter of the light beam 60 on the build surface 8s of a second beam diameter D2, which is larger than the first beam diameter D1, may be emitted to a second region r2, which is different from the first region r1, in the same layer 8a.

For example, as shown in FIGS. 5A to 5D, in the manufacturing step S20, at least a part of the region Rc corresponding to the contour of the manufactured object 15 in the same layer 8a may be set as the first region r1, and at least a part of another region (for example, the region Ri on the inner side of the region Rc) other than the region Rc corresponding to the contour thereof may be set as the second region r2.

Accordingly, with the reduction in the number of bead passes, it is possible to shorten the time required for the manufacturing.

For example, as shown in FIGS. 5A to 5D, in the manufacturing step S20, the entire region Rc corresponding to the contour of the manufactured object 15 in the same layer 8a may be set as the first region r1. Further, the entire region other than the region Rc corresponding to the contour of the manufactured object 15 may be set as the second region r2.

In some embodiments, in implementing the manufacturing step S20, in a case where the light beam 60 is emitted to the second region r2 in the layer 8a, the control device 20 implements the beam diameter changing step S21. That is, the control device 20 controls each section of the light beam irradiation part 9 such that the beam diameter of the light beam 60 on the build surface 8s becomes the second beam diameter D2. A control content of each section of the light beam irradiation part 9 by the control device 20 will be described below.

In some embodiments, in implementing the manufacturing step S20, in a case where the light beam 60 is emitted to the first region r1 in the layer 8a, the control device 20 implements the beam diameter changing step S21. That is, the control device 20 controls each section of the light beam irradiation part 9 such that the beam diameter of the light beam 60 on the build surface 8s becomes the first beam diameter D1. A control content of each section of the light beam irradiation part 9 by the control device 20 will be described below.

In some embodiments, in implementing the manufacturing step S20, in a case where the light beam 60 is emitted to the second region r2 in the layer 8a, the control device 20 implements the beam diameter changing step S21. That is, the control device 20 controls each section of the light beam irradiation part 9 such that the beam diameter of the light beam 60 on the build surface 8s becomes the second beam diameter D2. A control content of each section of the light beam irradiation part 9 by the control device 20 will be described below.

In some embodiments, the control device 20 implements the beam diameter changing step S21 and then the beam irradiation step S23. In the beam irradiation step S23, the control device 20 controls each section of the light beam irradiation part 9 such that the light beam 60 having the beam diameter of the light beam 60 set in the beam diameter changing step S21 is emitted to the layer 8a. A control content of each section of the light beam irradiation part 9 by the control device 20 will be described below.

### (Case of Embodiment Shown in FIG. 4A)

In the light beam irradiation part 9A shown in FIG. 4A, in implementing the manufacturing step S20, the control device 20 controls each section of the light beam irradiation part 9A as follows.

### (1) Case Where the Light Beam 60 is Emitted to the First Region r1 in the Layer 8a

The control device 20 outputs the control signal to the focal position changing device 95 in the beam diameter changing step S21. The control signal is a control signal for causing the focal position changing device 95 to change the position of the beam waist of the second light beam 65, which is output from the focal position changing device 95, such that the beam diameter of the second light beam 65 on the build surface 8s becomes the first beam diameter D1. Accordingly, the position of the beam waist of the second light beam 65 can be adjusted such that the beam diameter of the second light beam 65 on the build surface 8s becomes the first beam diameter D1.

That is, as described above, in the second light beam 65, the pattern of the intensity distribution or the beam diameter of the second light beam 65 differs depending on the position of the second light beam 65 in the axial direction from the beam waist. Therefore, with the change of the position of the beam waist by the focal position changing device 95 as appropriate, the beam diameter of the second light beam 65 on the build surface 8s can be set to the first beam diameter D1.

In a case where the beam diameter of the second light beam 65 is the first beam diameter D1 at the position of the beam waist of the second light beam 65, which is output from the focal position changing device 95, the control signal may be a control signal for causing the position of the beam waist of the second light beam 65, which is output from the focal position changing device 95, to match the build surface 8s.

In the beam irradiation step S23, the control device 20 outputs the control signal to the first oscillation device 91A to output the first light beam 61 and outputs the control signal to the scanning device 97 such that the second light beam 65, which is output from the focal position changing device 95, is emitted to the first region r1.

Accordingly, the second light beam 65 having the first beam diameter D1 on the build surface 8s is emitted to the first region r1.

(2) Case Where the light beam 60 is emitted to the second region r2 in the layer 8a

The control device 20 outputs the control signal to the focal position changing device 95 in the beam diameter changing step S21. The control signal is a control signal for causing the focal position changing device 95 to change the position of the beam waist of the second light beam 65, which is output from the focal position changing device 95, such that the beam diameter of the second light beam 65 on the build surface 8s becomes the second beam diameter D2. Accordingly, the position of the beam waist of the second light beam 65 can be adjusted such that the beam diameter of the second light beam 65 on the build surface 8s becomes the second beam diameter D2.

That is, as described above, in the second light beam 65, the pattern of the intensity distribution or the beam diameter of the second light beam 65 differs depending on the position of the second light beam 65 in the axial direction from the beam waist. Therefore, with the change of the position of the beam waist by the focal position changing device 95 as appropriate, the beam diameter of the second light beam 65 on the build surface 8s can be set to the second beam diameter D2.

In a case where the beam diameter of the second light beam 65 is the first beam diameter D1 at the position of the beam waist of the second light beam 65, which is output from the focal position changing device 95, the control signal may be a control signal for shifting the position of the beam waist of the second light beam 65, which is output from the focal position changing device 95, from the build surface 8s.

That is, in this case, with the intentional shift of the position of the beam waist of the second light beam 65 from the build surface 8s, the beam diameter of the second light beam 65 on the build surface 8s can be set to the second beam diameter D2 larger than the first beam diameter D1.

In this case, the control device 20 controls the focal position changing device 95 such that the beam waist shifts from the build surface 8s.

In this manner, with the intentional shift of the position of the beam waist from the build surface 8s, it is possible to increase the beam diameter of the light beam 60 on the build surface 8s during the manufacturing.

In the beam irradiation step S23, the control device 20 outputs the control signal to the first oscillation device 91A to output the first light beam 61 and outputs the control signal to the scanning device 97 such that the second light beam 65, which is output from the focal position changing device 95, is emitted to the second region r2.

Accordingly, the second light beam 65 having the second beam diameter D2 on the build surface 8s is emitted to the second region r2.

### (Case of Embodiment Shown in FIG. 4B)

In the light beam irradiation part 9A shown in FIG. 4B, in implementing the manufacturing step S20, the control device 20 controls each section of the light beam irradiation part 9B as follows.

### (1) Case Where the Light Beam 60 is Emitted to the First Region r1 in the Layer 8a

The control device 20 outputs the control signal to the focal position changing device 95 in the beam diameter changing step S21. The control signal is a control signal for causing the focal position changing device 95 to change the position of the beam waist of the first light beam 61, which is output from the focal position changing device 95, such that the beam diameter of the first light beam 61 on the build surface 8s becomes the first beam diameter D1. Accordingly, the position of the beam waist of the first light beam 61 can be adjusted such that the beam diameter of the first light beam 61 on the build surface 8s becomes the first beam diameter D1.

That is, as described above, the first light beam 61 is the light beam 60 having the pattern of the intensity distribution in the TEM₀₀ mode, and the beam diameter of the first light beam 61 is the smallest in the beam waist and increases along the axial direction of the first light beam 61 as a distance from the beam waist increases. Therefore, with the change of the position of the beam waist by the focal position changing device 95 as appropriate, the beam diameter of the first light beam 61 on the build surface 8s can be set to the first beam diameter D1.

In a case where the beam diameter of the first light beam 61 is the first beam diameter D1 at the position of the beam waist of the first light beam 61, which is output from the focal position changing device 95, the control signal may be a control signal for causing the position of the beam waist of the first light beam 61, which is output from the focal position changing device 95, to match the build surface 8s.

In the beam irradiation step S23, the control device 20 outputs the control signal to the first oscillation device 91A to output the first light beam 61 and outputs the control signal to the scanning device 97 such that the first light beam 61, which is output from the focal position changing device 95, is emitted to the first region r1.

Accordingly, the first light beam 61 having the first beam diameter D1 on the build surface 8s is emitted to the first region r1.

### (2) Case Where the Light Beam 60 is Emitted to the Second Region r2 in the Layer 8a

The control device 20 outputs the control signal to the focal position changing device 95 in the beam diameter changing step S21. The control signal is a control signal for causing the focal position changing device 95 to change the position of the beam waist of the first light beam 61, which is output from the focal position changing device 95, such that the beam diameter of the first light beam 61 on the build surface 8s becomes the second beam diameter D2. Accordingly, the position of the beam waist of the first light beam 61 can be adjusted such that the beam diameter of the first light beam 61 on the build surface 8s becomes the second beam diameter D2.

That is, as described above, the beam diameter of the first light beam 61 is the smallest in the beam waist and increases along the axial direction of the first light beam 61 as a distance from the beam waist increases. Therefore, with the change of the position of the beam waist by the focal position changing device 95 as appropriate, the beam diameter of the first light beam 61 on the build surface 8s can be set to the second beam diameter D2.

In a case where the beam diameter of the first light beam 61 is the first beam diameter D1 at the position of the beam waist of the first light beam 61, which is output from the focal position changing device 95, the control signal may be a control signal for shifting the position of the beam waist of the first light beam 61, which is output from the focal position changing device 95, from the build surface 8s.

That is, in this case, with the intentional shift of the position of the beam waist of the first light beam 61 from the build surface 8s, the beam diameter of the first light beam 61 on the build surface 8s can be set to the second beam diameter D2 larger than the first beam diameter D1.

In this case, the control device 20 controls the focal position changing device 95 such that the beam waist shifts from the build surface 8s.

In this manner, with the intentional shift of the position of the beam waist from the build surface 8s, it is possible to increase the beam diameter of the light beam 60 on the build surface 8s during the manufacturing.

In the beam irradiation step S23, the control device 20 outputs the control signal to the first oscillation device 91A to output the first light beam 61 and outputs the control signal to the scanning device 97 such that the first light beam 61, which is output from the focal position changing device 95, is emitted to the second region r2.

Accordingly, the first light beam 61 having the second beam diameter D2 on the build surface 8s is emitted to the second region r2.

### (Case of Embodiment Shown in FIG. 4C)

In the light beam irradiation part 9C shown in FIG. 4C, in implementing the manufacturing step S20, the control device 20 controls each section of the light beam irradiation part 9C as follows.

### (1) Case Where the Light Beam 60 is Emitted to the First Region r1 in the Layer 8a

The control device 20 outputs the control signal to the second oscillation device 91B and the focal position changing device 95 as follows such that the beam diameter on the build surface 8s becomes the first beam diameter D1 in cooperation with the second oscillation device 91B and the focal position changing device 95.

The control device 20 outputs the control signal to the focal position changing device 95 in the beam diameter changing step S21. The control signal is a control signal, for example, for changing the position of the beam waist of the third light beam 67 such that the beam diameter of the third light beam 67, which is output from the focal position changing device 95, on the build surface 8s becomes the first beam diameter D1.

In the beam irradiation step S23, the control device 20 outputs the control signal to the second oscillation device 91B and the scanning device 97.

Here, the control signal output to the second oscillation device 91B is a control signal for changing and outputting the intensity distribution of the third light beam 67 such that the beam diameter of the third light beam 67, which is output from the focal position changing device 95, on the build surface 8s becomes the first beam diameter D1.

Further, the control signal output to the scanning device 97 is a control signal for controlling the scanning device 97 such that the third light beam 67, which is output from the focal position changing device 95, is emitted to the first region r1.

Accordingly, the third light beam 67 having the first beam diameter D1 on the build surface 8s is emitted to the first region r1.

### (2) Case Where the Light Beam 60 is Emitted to the Second Region r2 in the Layer 8a

The control device 20 outputs the control signal to the second oscillation device 91B and the focal position changing device 95 as follows such that the beam diameter on the build surface 8s becomes the second beam diameter D2 in cooperation with the second oscillation device 91B and the focal position changing device 95.

The control device 20 outputs the control signal to the focal position changing device 95 in the beam diameter changing step S21. The control signal is a control signal, for example, for changing the position of the beam waist of the third light beam 67 such that the beam diameter of the third light beam 67, which is output from the focal position changing device 95, on the build surface 8s becomes the second beam diameter D2.

In the beam irradiation step S23, the control device 20 outputs the control signal to the second oscillation device 91B and the scanning device 97.

Here, the control signal output to the second oscillation device 91B is a control signal for changing and outputting the intensity distribution of the third light beam 67 such that the beam diameter of the third light beam 67, which is output from the focal position changing device 95, on the build surface 8s becomes the second beam diameter D2.

Further, the control signal output to the scanning device 97 is a control signal for controlling the scanning device 97 such that the third light beam 67, which is output from the focal position changing device 95, is emitted to the second region r2.

Accordingly, the third light beam 67 having the second beam diameter D2 on the build surface 8s is emitted to the second region r2.

In the embodiment shown in FIG. 4C, in a case where the beam diameter of the third light beam 67 becomes the first beam diameter D1 and the second beam diameter D2 on the build surface 8s only by changing the intensity distribution of the third light beam 67 in the second oscillation device 91B, the focal position changing device 95 may be omitted.

As in the embodiments shown in FIGS. 4A, 4B, and 4C, in the manufacturing step S20, with the change of the positional relationship between the beam waist of the light beam 60 and the build surface 8s, the beam diameter of the light beam 60 on the build surface 8s may be changed during the manufacturing.

As described above, in a case where the positional relationship between the beam waist of the light beam 60 and the build surface 8s is changed, the beam diameter of the light beam 60 on the build surface 8s is changed.

Therefore, according to the embodiments shown in FIGS. 4A, 4B, and 4C, it is possible to change the beam diameter of the light beam 60 on the build surface 8s during the manufacturing.

As described above, in the embodiments shown in FIGS. 4A, 4B, and 4C, the light beam irradiation part 9 is configured to be able to change the diameter of the light beam 60 on the build surface 8s during the manufacturing in the same layer 8a described above.

Accordingly, since the beam diameter of the light beam 60 on the build surface 8s can be changed during the manufacturing in the same layer 8a, with the increase in the width of the formed bead by making the beam diameter of the light beam 60 larger than the beam diameter of the light beam 60 in the additive manufacturing in the related art and with the reduction in the number of bead passes by widening the overlap margin between beads, it is possible to shorten the time required for the manufacturing.

As described above, in the embodiments shown in FIGS. 4A, 4B, and 4C, the light beam irradiation part 9 may include the focal position changing device 95 that changes the positional relationship between the beam waist of the light beam 60 and the build surface 8s during the manufacturing.

As described above, in a case where the positional relationship between the beam waist of the light beam 60 and the build surface 8s is changed, the beam diameter of the light beam 60 on the build surface 8s is changed.

Therefore, according to the embodiments shown in FIGS. 4A, 4B, and 4C, it is possible to change the beam diameter of the light beam 60 on the build surface 8s during the manufacturing.

As in the embodiment shown in FIGS. 4A and 4C, in the manufacturing step S20, with the change of the pattern of the intensity distribution of the light beam 60 on the build surface 8s, the beam diameter of the light beam 60 on the build surface 8s may be changed during the manufacturing.

As described above, in a case where the pattern of the intensity distribution of the light beam 60 on the build surface 8s is changed, the beam diameter of the light beam 60 on the build surface 8s is changed.

Therefore, according to the embodiments shown in FIGS. 4A and 4C, it is possible to change the beam diameter of the light beam 60 on the build surface 8s during the manufacturing.

As in the embodiment shown in FIG. 4A, in the manufacturing step S20, with the conversion of the intensity distribution of the light beam 60, which is output from the oscillation device 91 (first oscillation device 91A) that outputs the light beam 60, by the conversion device 93, the pattern of the intensity distribution of the light beam 60 on the build surface 8s may be changed.

That is, in the embodiment shown in FIG. 4A, the light beam irradiation part 9 may include the oscillation device 91 that outputs the light beam 60 and the conversion device 93 that converts the pattern of the intensity distribution of the light beam 60, which is output from the oscillation device 91.

Accordingly, with the use of the conversion device 93, it is possible to relatively easily change the pattern of the intensity distribution of the light beam 60 on the build surface 8s. Further, with addition of the conversion device 93 to an optical system of an additive manufacturing device in the related art, it is possible to relatively easily change the pattern of the intensity distribution.

As in the embodiment shown in FIG. 4C, in the manufacturing step S20, with the change of the intensity distribution of the light beam 60, which is output from the oscillation device 91 (second oscillation device 91B) that outputs the light beam 60, the intensity distribution of the light beam 60 on the build surface 8s may be changed.

That is, as in the embodiment shown in FIG. 4C, in the manufacturing step S20, with the change of the intensity distribution of the light beam 60, which is output from the oscillation device 91 (second oscillation device 91B) that outputs the light beam 60, the pattern of the intensity distribution of the light beam 60 on the build surface 8s may be changed or the beam profile may be changed without changing the pattern of the intensity distribution.

As described above, in the embodiment shown in FIG. 4C, the light beam irradiation part 9 may include the oscillation device 91 (second oscillation device 91B) that can change the intensity distribution of the light beam 60 to be output.

Accordingly, the conversion device 93 that converts the intensity distribution of the light beam 60 is unnecessary, and it is possible to suppress an increase in the number of components of an optical system after the oscillation device 91 (second oscillation device 91B).

In some embodiments described above, the second beam diameter D2 may be, for example, larger than one time and equal to or less than five times the first beam diameter D1.

Since the hatch spacing Ph can be increased as the second beam diameter D2 is larger, the second beam diameter D2 compared with the first beam diameter D1 is preferably larger. Therefore, the second beam diameter D2 may be, for example, larger than one time the first beam diameter D1.

However, an amount of heat input per unit area on the build surface 8s becomes smaller as the second beam diameter D2 is larger. Thus, in order to increase the second beam diameter D2 to a certain extent or more, it is necessary to reduce a scanning speed or to increase the output of the light beam 60 from the oscillation device 91. In a case where the scanning speed is reduced, the time required for the manufacturing becomes long. Thus, the effect of shortening the manufacturing time may not be obtained as expected. Further, since the output of the light beam 60 from the oscillation device 91 can be increased only up to an upper limit of the output of the oscillation device 91, the oscillation device 91 is requested to be changed in a case where a larger output is needed, which becomes a burden in terms of costs of the device. Considering the above facts, the second beam diameter D2 may be equal to or less than five times the first beam diameter D1.

Accordingly, it is possible to effectively shorten the time required for the manufacturing while suppressing an increase in cost.

### (Regarding Manufacturing of Thin Wall Portion)

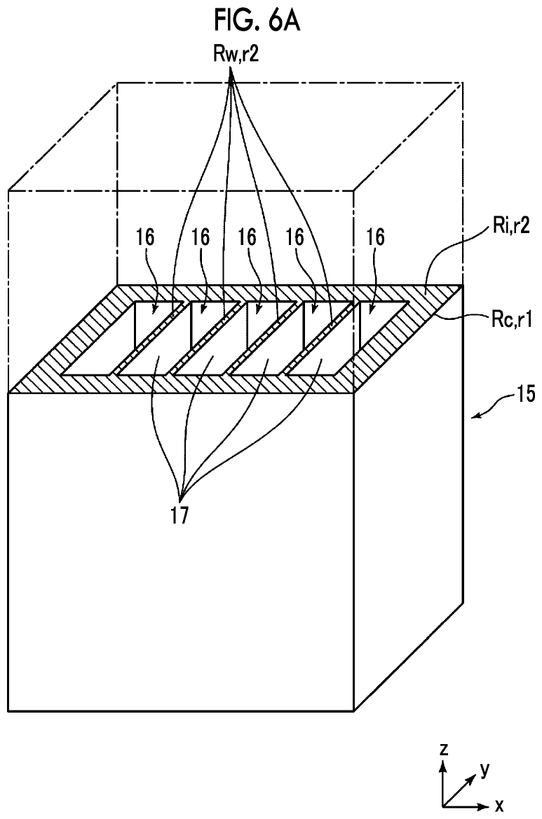

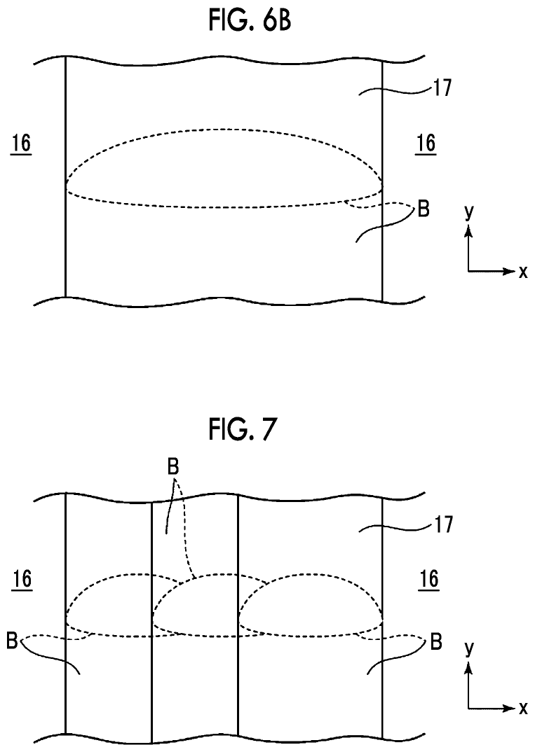

FIG. 6A is a diagram schematically showing a case where the manufactured object 15 includes a thin wall portion 17 having a relatively thin thickness. In FIG. 6A, a cross section of the manufactured object 15 cut along a xy plane is illustrated, and the cross section is hatched. This hatching does not represent the locus of the light beam 60 as shown in FIG. 5C.

The manufactured object 15 may include the thin wall portion 17 having the relatively thin thickness. For example, there is a case where a wall portion that separates a vacant space inside the manufactured object 15 into a plurality of vacant spaces 16 is provided. Further, in this case, a thickness of the wall portion may be relatively thin. For example, it is conceivable that the manufactured object 15 configures a part of a heat exchanger, and two or more fluids having different temperatures are circulated to the plurality of vacant spaces (flow paths) 16 separated by the thin wall portion 17 to exchange heat between fluids via the thin wall portion 17. In such a case, from the viewpoint of heat exchange efficiency, it is preferable that the thin wall portion 17 has a thin thickness.

Here, as shown in FIG. 6A, it is assumed that the thin wall portion 17 extends in the z-direction, that is, in the vertical direction in a case where the manufactured object 15 is manufactured in the three-dimensional additive manufacturing device 1. Further, for convenience of description, it is assumed that the thin wall portion 17 extends in the z-direction and the y-direction. The thickness of the thin wall portion 17 is a dimension of the thin wall portion 17 in the x-direction.

FIG. 6B is a diagram representing a cross section of the thin wall portion 17 shown in FIG. 6A, as viewed from the z direction.

FIG. 7 is a diagram representing a case where the manufactured object 15 as shown in FIG. 6A is manufactured by the three-dimensional additive manufacturing device in the related art, and is a diagram representing the cross section of the thin wall portion 17 as viewed from the z-direction.

FIGS. 6B and 7 represent, by a broken line, a shape of a cross section of a bead B constituting the thin wall portion 17, as viewed from an extending direction (y direction) of the bead B. The shape of the bead B represented by the broken line represents one layer of the layer 8a.

In a case where the thin wall portion 17 is manufactured in the three-dimensional additive manufacturing device in the related art, for example, a plurality of beads B are arranged in a thickness direction (x direction) of the thin wall portion 17 to manufacture the thin wall portion 17. In a case where the thickness of the thin wall portion 17 is, for example, about 0.3 mm to 0.5 mm, for example, three beads B are arranged in the thickness direction (x direction) of the thin wall portion 17 to form the thin wall portion 17 in the case of manufacturing the thin wall portion 17 in the three-dimensional additive manufacturing device in the related art.

In the three-dimensional additive manufacturing device in the related art, the beam diameter of the light beam 60 on the build surface 8s in the case of manufacturing the thin wall portion 17 is a beam diameter corresponding to the first beam diameter D1 described above.

On the other hand, in the additive manufacturing method according to some embodiments, in a case where the thin wall portion 17 is manufactured, as described above, the beam diameter of the light beam 60 on the build surface 8s may be set to the second beam diameter D2, which is larger than the first beam diameter D1, for the manufacturing. That is, in the additive manufacturing method according to some embodiments, in the manufacturing of the manufactured object 15, a region corresponding to the thin wall portion 17, which is a wall portion extending in a lamination direction (z direction) of the layer 8a, may be set as the second region r2.

Accordingly, since the number of beads B constituting the thin wall portion 17 can be reduced, it is possible to shorten the time required for manufacturing the thin wall portion 17.

For example, in a case where the thickness of the thin wall portion 17 is, for example, about 0.3 mm to 0.5 mm, in the additive manufacturing method according to some embodiments, the thin wall portion 17 can be manufactured by laminating one bead in the z direction.

In the additive manufacturing method according to some embodiments, for example, as shown in FIG. 6A, it is possible to emit the light beam 60 having the beam diameter of the light beam 60 on the build surface 8s of the first beam diameter D1 in the same layer 8a, setting at least a part of the region Rc corresponding to the contour of the outer surface of the manufactured object 15 as the first region r1. In the additive manufacturing method according to some embodiments, it is possible to emit the light beam 60 having the beam diameter of the light beam 60 on the build surface 8s of the second beam diameter D2 in the same layer 8a, setting at least a part of the region Ri, on the inner side of the region Rc corresponding to the contour of the outer surface of the manufactured object 15, including a region Rw corresponding to the thin wall portion 17 as the second region r2.

In the additive manufacturing method according to some embodiments, the light beam 60 having the beam diameter of the light beam 60 on the build surface 8s of the first beam diameter D1 may be emitted in the same layer 8a, setting the entire region Rc corresponding to the contour of the outer surface of the manufactured object 15 as the first region r1. In the additive manufacturing method according to some embodiments, the light beam 60 having the beam diameter of the light beam 60 on the build surface 8s of the second beam diameter D2 may be emitted in the same layer 8a, setting the entire region Ri, on the inner side of the region Rc corresponding to the contour of the outer surface of the manufactured object 15, including the region Rw corresponding to the thin wall portion 17 as the second region r2.

The present disclosure is not limited to the embodiments described above and includes a form in which a modification is added to the embodiments described above or a form in which the above forms are combined as appropriate.

For example, in the embodiment shown in FIG. 4C described above, the focal position changing device 95 may be omitted.

The contents described in each embodiment are understood as follows, for example.

(1) According to at least one embodiment of the present disclosure, an additive manufacturing method includes a step (powder bed forming step S10) of supplying a raw-material powder 30 to form a layer 8a of the raw-material powders 30, and a step (manufacturing step S20) of manufacturing a part of a manufactured object 15 by emitting a light beam 60 to the layer 8a to melt and solidify the raw-material powders 30 of the layer 8a. In the step of manufacturing (manufacturing step S20), a beam diameter of the light beam 60 on a build surface 8s is changed during the manufacturing in the same layer 8a.

According to the method (1), since the beam diameter of the light beam 60 on the build surface 8s can be changed during manufacturing in the same layer 8a, with the reduction in the number of bead passes, it is possible to shorten the time required for the manufacturing.

(2) In some embodiments, according to the method (1), in the step of manufacturing (manufacturing step S20), a positional relationship between a beam waist of the light beam 60 and the build surface 8s may be changed to change the beam diameter of the light beam 60 on the build surface 8s during the manufacturing.

In a case where the positional relationship between the beam waist of the light beam 60 and the build surface 8s is changed, the beam diameter of the light beam 60 on the build surface 8s is changed.

Therefore, according to the method (2), it is possible to change the beam diameter of the light beam 60 on the build surface 8s during the manufacturing.

(3) In some embodiments, according to the method (1), in the step of manufacturing (manufacturing step S20), a pattern of an intensity distribution of the light beam 60 on the build surface 8s may be changed to change the beam diameter of the light beam 60 on the build surface 8s during the manufacturing.

In a case where the pattern of the intensity distribution of the light beam 60 on the build surface 8s is changed, the beam diameter of the light beam 60 on the build surface 8s is changed.

Therefore, according to the method (3), it is possible to change the beam diameter of the light beam 60 on the build surface 8s during the manufacturing.

(4) In some embodiments, according to the method (3), in the step of manufacturing (manufacturing step S20), the intensity distribution of the light beam 60 output from an oscillation device 91 that outputs the light beam 60 may be converted by a conversion device 93 to change the pattern of the intensity distribution of the light beam 60 on the build surface 8s.

According to the method (4), with the use of the conversion device 93, it is possible to relatively easily change the pattern of the intensity distribution of the light beam 60 on the build surface 8s.

(5) In some embodiments, according to the method (3), in the step of manufacturing (manufacturing step S20), the intensity distribution of the light beam 60 output from an oscillation device 91 (second oscillation device 91B) that outputs the light beam 60 may be changed to change the intensity distribution of the light beam 60 on the build surface 8s.

According to the method (5), the conversion device 93 that converts the intensity distribution of the light beam 60 is unnecessary, and it is possible to suppress an increase in the number of components of an optical system after the oscillation device 91 (second oscillation device 91B).

(6) In some embodiments, according to any one of the methods (1) to (5), in the step of manufacturing (manufacturing step S20), the light beam 60 having the beam diameter of the light beam 60 on the build surface 8s of a first beam diameter D1 may be emitted to a first region r1 in the same layer 8a, and the light beam having the beam diameter of the light beam 60 on the build surface 8s of a second beam diameter D2, which is larger than the first beam diameter D1, may be emitted to a second region r2, which is different from the first region r1, in the same layer 8a.

According to the method (6), for example, in a case where the light beam 60 is emitted setting the region Rc corresponding to the contour of the manufactured object 15 as the first region r1 and setting the region on the inner side of the region Rc corresponding to the contour of the manufactured object 15 as the second region r2, with the reduction in the number of bead passes, it is possible to shorten the time required for the manufacturing.

(7) In some embodiments, according to the method (6), the second beam diameter D2 may be larger than one time and equal to or less than five times the first beam diameter D1.

According to the method (7), it is possible to effectively shorten the time required for the manufacturing while suppressing an increase in cost.

(8) In some embodiments, according to the method (6) or (7), in the step of manufacturing (manufacturing step S20), at least a part of a region Rc corresponding to a contour of the manufactured object 15 in the same layer 8a may be set as the first region r1, and at least a part of another region other than the region Rc corresponding to the contour may be set as the second region r2.

According to the method (8), with the reduction in the number of bead passes, it is possible to shorten the time required for the manufacturing.

(9) In some embodiments, according to the methods (6) to (8), a region corresponding to a wall portion extending in a lamination direction of the layer 8a in the same layer 8a may be set as the second region r2.

According to the method (9), it is possible to shorten the time required for manufacturing the wall portion.

(10) According to at least one embodiment of the present disclosure, an additive manufacturing device (three-dimensional additive manufacturing device 1) includes a powder bed forming part 5 having a base plate 2 where a layer 8a made of supplied raw-material powders 30 is formed, and a light beam irradiation part 9 that is able to emit a light beam 60 to the layer 8a. The light beam irradiation part 9 is configured to be able to change a beam diameter of the light beam 60 on a build surface 8s during manufacturing in the same layer 8a.

With the configuration (10), since the beam diameter of the light beam 60 on the build surface 8s can be changed during the manufacturing in the same layer 8a, with the increase in the beam diameter of the formed bead by making the beam diameter of the light beam 60 larger than the beam diameter of the light beam 60 in the additive manufacturing in the related art and with the reduction in the number of bead passes, it is possible to shorten the time required for the manufacturing.

(11) In some embodiments, according to the configuration of (10) above, the light beam irradiation part 9 may include a focal position changing device 95 that changes a positional relationship between a beam waist of the light beam 60 and the build surface 8s during the manufacturing.

In a case where the positional relationship between the beam waist of the light beam 60 and the build surface 8s is changed, the beam diameter of the light beam 60 on the build surface 8s is changed.

Therefore, with the configuration (11), it is possible to change the beam diameter of the light beam 60 on the build surface 8s during the manufacturing.

(12) In some embodiments, according to the configuration of (11) above, a control device 20 that controls the focal position changing device 95 such that the beam waist shifts from the build surface 8s may be included.

With the configuration (12), with the intentional shift of the position of the beam waist from the build surface 8s, it is possible to increase the beam diameter of the light beam 60 on the build surface 8s during the manufacturing.

(13) In some embodiments, according to any one of the configurations of (10) to (12) above, the light beam irradiation part 9 may include an oscillation device 91 that outputs the light beam 60, and a conversion device 93 that converts a pattern of an intensity distribution of the light beam 60 output from the oscillation device 91.

With the configuration (13), with the use of the conversion device 93, it is possible to relatively easily change the pattern of the intensity distribution of the light beam 60 on the build surface 8s. Further, with addition of the conversion device 93 to an optical system of an additive manufacturing device in the related art, it is possible to relatively easily change the pattern of the intensity distribution.

(14) In some embodiments, according to the configuration of (10) above, the light beam irradiation part 9 may include an oscillation device 91 (second oscillation device 91B) that is able to change an intensity distribution of the light beam 60 to be output.

With the configuration (14), the conversion device 93 that converts the intensity distribution of the light beam 60 is unnecessary, and it is possible to suppress the increase in the number of components of the optical system after the oscillation device 91 (second oscillation device 91B).

### REFERENCE SIGNS LIST

1 three-dimensional additive manufacturing device (additive manufacturing device)

2 base plate

5 powder bed forming part

8 powder bed

8a layer

9 light beam irradiation part

15 manufactured object

20 control device

30 raw-material powder

60 light beam

91 oscillation device

93 conversion device

95 focal position changing device

97 scanning device

1-14. (canceled)

15. An additive manufacturing device comprising:
a powder bed forming part having a base plate where a layer made of supplied raw-material powders is formed; and
a light beam irradiation part that is able to emit a light beam to the layer, wherein
the light beam irradiation part includes an oscillation device configured to be able to coaxially output two light beams having different intensity distributions.

16. The additive manufacturing device according to claim 15, wherein the light beam irradiation part is configured to be able to change a beam diameter of the light beam on a build surface during manufacturing in the same layer.

17. The additive manufacturing device according to claim 15, wherein the light beam irradiation part further includes a focal position changing device that changes a positional relationship between a beam waist of the light beam and the build surface during the manufacturing.

18. The additive manufacturing device according to claim 17, further comprising:
a control device that controls the focal position changing device such that the beam waist shifts from the build surface.

19. The additive manufacturing device according to claim 15, wherein the light beam irradiation part further includes:
an oscillation device that outputs the light beam; and
a conversion device that converts a pattern of an intensity distribution of the light beam output from the oscillation device.

20. The additive manufacturing device according to claim 15, wherein the light beam irradiation part further includes an oscillation device that is able to change an intensity distribution of the light beam to be output.
